(19) United States
(12) Patent Application Publication
(10) Pub. No.: US 2025/0117505 A1
(43) Pub. Date: Apr. 10, 2025

(54) OWNER-MANAGED PASSWORD BASED FILE ACCESS

(71) Applicant: Bank of America Corporation, Charlotte, NC (US)

(72) Inventors: Jo-Ann Taylor, Godalming Surrey (GB); Anna Hollenberg, Oak Park, IL (US); Randy Rustman, Jacksonville, FL (US); Mark E. Harris, Houston, TX (US); Thomas Daniel, Plainfield, IL (US); Dayna Petrovskis, Aurora, CO (US)

(21) Appl. No.: 18/376,789

(22) Filed: Oct. 4, 2023

(51) Int. Cl. G06F 21/62; G06F 21/32; G06F 21/33

(52) U.S. Cl. CPC G06F 21/6209; G06F 21/32; G06F 21/33; G06F 2221/2141

(57) ABSTRACT

Methods and systems are provided for managing access to a file. The methods and systems may include locking access to the file using a password accessible security setting. The methods and systems may include designating a password as an unlock password. The methods and systems may include communicating the password to a first group of users. The methods and systems may include providing a prompt to input the unlock password upon a request to access the file. The methods and systems may include providing access to the file in response to inputting the unlock password. The methods and systems may include authenticating each unauthenticated user that inputs the unlock password. The methods and systems may include deactivating the password as the unlock password. The methods and systems may include removing authentication from a user in response to the user meeting a predetermined condition.

### FIELD OF TECHNOLOGY

Aspects of the disclosure relate to technology for managing access to files.

### BACKGROUND OF THE DISCLOSURE

File sharing among users may be commonplace. Users may create groups to share files. These groups may be business, family, friend or other types of groups. The groups may share files between computers over a network or between a computer and a server over the Internet. Access to the files may be password-protected.

Currently, password-protected files may be cumbersome to use and operate. The file owner may share the password with a user or group of users. However, the file owner may not know whether the intended users accessed the file. The users may be able to access the file with the password but over time may forget the password. The users may become locked out of the file. The file owner may forget the password as well. The file owner may become locked out of the file.

Password-protected files may be protected so long as the password remains restricted to users given access to the password by the file owner. The file owner may be unable to prevent an intended user from sharing the password with an unintended user. The file owner may not be aware whether an unintended user is accessing the file. The file owner may not be able to identify which intended user shared and/or compromised the password. The file owner may change the password. However, the intended user may share the password again and/or other intended users may not receive or be aware of the updated password.

Enterprises may create dedicated spaces to view protected files. The enterprises may grant access to specific users for each dedicated space. Each specific user may have varying security clearances. Multiple dedicated spaces may be created to accommodate all the permutations of users with varying security clearances. It may be too cumbersome to create and maintain all these spaces.

Therefore, it would be desirable to create a new approach to grant access to a shared file. It would be further desirable to provide the file owner with tools to manage access to the file. It would be further desirable to simplify the need to create dedicated spaces for each permutation of users.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative apparatus in accordance with principles of the disclosure;

FIG. 2 shows another illustrative apparatus in accordance with principles of the disclosure;

FIG. 3 shows an illustrative flowchart in accordance with principles of the disclosure;

FIG. 4 shows an illustrative diagram in accordance with principles of the disclosure;

FIG. 5 shows another illustrative diagram in accordance with principles of the disclosure; and

FIG. 6 shows yet another illustrative diagram in accordance with principles of the disclosure.

### DETAILED DESCRIPTION OF THE DISCLOSURE

A file owner may share a file with a group of users. The file owner may determine who can access the file. The file owner may determine who to remove from accessing the file. The file owner may manage access to the file manually. The file owner may automatically manage access to the file using the methods and systems provided below.

Methods and systems are provided for managing access to a file.

The methods and systems may include saving the file. The file may be saved to a server, a local network and/or a local hard drive. The file may be configured with a password-accessible security setting. The file may be locked using the password-accessible security setting. A password may be designated as an unlock password. Anyone may request access to the file.

The file owner may designate a group of users who are intended to access the file. The group of users may include a list of the group of users. The file owner may save the list of the group of users with the file. The list of the group of users may include a list of unique identifiers associated with the respective members of the group of users.

The unique identifiers may include an email identity, a phone number identity, an enterprise network identity, a biometric identifier or personal identifiable information. The biometric identifier may include a fingerprint, a retinal scan, or any other suitable biometric identifier. The personal identifiable information may include a social security number, a driver's license number, a financial institution account number, an address or any other suitable personal identifiable information.

The methods and systems may include communicating the password to the group of users. The communication may be via an email address, phone number or physical address associated with the respective user. The communication may be via an audio message or text message.

The methods and systems may include providing a prompt upon a request to access the file. The prompt may request the user to input the unlock password. The prompt may include multiple prompts. One of the prompts may include the prompt for the unlock password. Another of the prompts may include a prompt for a unique identifier. The prompt to input the unique identifier may precede the prompt to input the unlock password. The prompts may be provided simultaneously.

The methods and systems may include providing access to the file in response to inputting the unlock password in the unlock password prompt. The access may be provided upon inputting the unlock password and a valid unique identifier. The unique identifier may be valid when the unique identifier appears on the list of the group of users. The methods and systems may include associating each user on the list of the group of users with one or more device identities. The unique identifier may be valid when the unique identifier appears on the list of the group of users and when the device identity of the device used to request access to the file is associated with the user and/or unique identifier.

The methods and systems may include authenticating an unauthenticated user. The authenticating may include the unauthenticated user inputting the unlock password in the unlock password prompt. The authenticating may include, after inputting a valid unlock password, recording the unique identifier of the unauthenticated user attempting to access the file. The authenticating may include placing the unique identifier in a list of authenticated users. The list of authenticated users may be stored with the file.

The methods and systems may include recording the unique identifier of each unauthenticated user attempting to access the file. The unique identifier may be recorded after being input in the prompt for the unique identifier. Upon inputting the unlock password the unique identifier of the unauthenticated user may be stored on the list of authenticated users. Upon inputting an incorrect unlock password the unique identifier may be stored in a list of users attempting to access the file. The list of users attempting to access the file may be analyzed. Unauthorized users who input an incorrect password a predetermined number of times may be prohibited from accessing the file. Unauthorized users, not part of the group of users may be prohibited from accessing the file.

Authenticated users may be provided direct access to the file. Authenticated user may bypass the prompt for the unlock password upon requests to access the file. Authenticated may not need to worry about forgetting the password. Authenticated users may use the password less often. Authenticated users may not need to write the password down. Authenticated users may be unlikely to compromise the password. Authenticated users may be unlikely to share the password.

The methods and systems may include comparing the unique identifier input by a user in the prompt. The unique identifier may be compared with the list of authenticated users. Users that input a unique identifier that matches a unique identifier on the list of authenticated users may be granted access to the file. The user may be granted access to the file without prompting the user for an unlock password.

The user may be logged in to a user account before requesting access to the file. The user account may be associated with the unique identifier. The user account may be associated with an email address or an enterprise account. The list of authenticated users may include the respective user accounts of each authenticated user.

The methods and systems may include comparing the user account upon a request to access the file. The user account may be compared with the list of authenticated users. When the user account matches a user account associated with an authenticated user on the list of authenticated users the authenticated user may be granted access to the file. The authenticated user may be granted access to the file without prompting the user for an unlock password. The authenticated user may be granted access to the file only when a device identity of the user's device matches a device identity associated with the authenticated user.

The methods and systems may include generating an alert in response to the authentication of a user. The alert may be an audio alert. The alert may be a text alert. The alert may be sent to the file owner. The alert may be sent to the group of users.

The methods and systems may include deactivating the password as the unlock password. The deactivating may be in response to the authentication of every user in the group of users. The file owner may deactivate the password as the unlock password at any suitable time.

Authenticating all intended users may make the password unnecessary. Deactivating the password may prevent unintended users from accessing the file. Unintended users may obtain the password maliciously, through social engineering, by mistake or from a member of the group of users.

The methods and systems may include designating a new password as the unlock password. Designating the new password may be in response to the deactivation of the old password. The file owner may designate the new password at any suitable time. The file owner may choose to keep the new password undisclosed. The file owner may choose to communicate the new password to a new group of users.

The methods and systems may include removing the authentication from a user. The authentication may be removed from a user in response to the user meeting a predetermined condition. The file owner may remove the authentication at any suitable time. Removing the authentication of a user may prompt the user to input an unlock password upon a subsequent request to access the file. Deactivating the old password may prevent the removed user from accessing the file.

The file owner may be able to access the list of authenticated users. The file owner may choose which authenticated user to remove from the list of authenticated users. The file owner may remove users from the list of authenticated users who are not part of the group of users. Users who are not part of the group of users may be removed automatically.

The predetermined conditions may include an elapse of a predetermined time and/or a change in a clearance level of a user. The elapse of the predetermined time may begin from the deactivation of the password. The elapse of the predetermined time may begin from the authentication of the user. The predetermined conditions may apply to all users. The predetermined conditions may apply to unintended users. The predetermined conditions may apply to users who are not members of the group of users.

The elapse of the predetermined time may be 5 minutes, 10 minutes, 15 minutes, 30 minutes, 1 hour, 2 hours, 6 hours, 12 hours, 1 day, 2 days, 1 week, 2 weeks, 1 month, 2 months or any other suitable time. The clearance level of a user may be stored with the file. The file may update the clearance level of the user. The update may occur every 30 minutes, 1 hour, 2 hours, 6 hours, 12 hours, 1 day, 2 days, 1 week or after any other suitable time period. The clearance level may be designated by the file owner. The clearance level may be designated by another source. The clearance level may be relayed to the file. A lowering of the clearance level of a user may cause the removal of the user's authentication.

The file owner may forget to include a user in the group of users. Another member of the group of users may share the password with the forgotten user. Waiting for an elapse of a predetermined time may allow for the forgotten user to access the file while the member of the group contacts the file owner to add the forgotten user to the group of users.

The methods and systems may include multiple unlock passwords. Inputting each unlock password in the unlock password prompt may grant access to the file. There may be two, three, four, five or any suitable number of unlock passwords.

The methods and systems may include communicating each unlock password to a different group of users. For example, a password may be communicated to a group of users. Another password may be communicated to another group of users. Yet another password may be communicated to yet another group of users.

Each respective password may grant different types of access to the file. The different types of access may include reading, commenting or editing access. Users may also be granted access to a list of authenticated users, access to a list of each group of users, access to predetermined removal conditions and access to details regarding who accessed the file. The details may include a length of time each user accessed the file, the number of times each user accessed the file, comments each user made on the file and edits each user made to the file.

The methods and systems may include authenticating a user upon input of any of the multiple unlock passwords. The authenticating may include associating the unique identifier of each user which inputted a specific password with a certain status. For example, a user inputting a password may associate the user's unique identifier with a first status. Another user inputting another password may associate the user's unique identifier with a second status. Yet another user inputting yet another password may associate the user's unique identifier with a third status.

The methods and systems may include granting respective access to users based on their status. For example, the first status may be granted read-only access to the file. The second status may be granted reading and commenting access to the file. The third status may be granted reading, commenting and editing access to the file. A fourth status may be granted reading, commenting and editing access to the file, viewing and editing access to the list of authenticated users and access to view details about each user that accessed the file. The fourth status may further be granted access to view and edit the group of users. The fourth status may still further be granted access to view and edit the predetermined conditions.

The file owner may communicate a unique password to each user. The file owner may be able to access the details of the password each user input. The file owner may be able to tell whether one of the unique passwords was entered multiple times. The file owner may be able to identify the specific user who shared or compromised the password. Identifying the user who shared or compromised the password may be automated.

The methods and systems may include prompting an authenticated user to input a unique identifier upon a request to access the file. The authenticated user may share the unique identifier. The authenticated user may compromise the unique identifier. The device identity of the user requesting access to the file may be compared with a device identity associated with the input unique identifier to prevent unintended users from accessing the file with the shared or stolen unique identifier.

Details about each user that input the unique identifier to gain access to the file can be assessed. The details may be able to determine whether multiple users are accessing the file with the same unique identifier. For example, accessing the file at the same time from different devices using the same unique identifier may indicate multiple users using the same unique identifier. Accessing the file at the same time from different cities may indicate multiple users using the same unique identifier.

Other analyses may be performed to determine patterns that might be associated with multiple users. For example, analyzing the length of time the file was accessed, analyzing the number of times the file was accessed, analyzing the writing style of the comments left on the file, analyzing the writing style of the edits made to the file, a combination thereof or any other suitable analysis to distinguish individual users from each other may be employed.

The methods and systems may include storing the unlock password and file access management algorithms with the file. Storing the unlock password and file access management algorithms with the file may obviate the need for creating separate dedicated spaces. Different types of files may not be able to be operated within every dedicated space. Removing the need for dedicated spaces may avoid this issue. The file may include interoperability between different systems. The file may be configured to be run in multiple systems.

One of ordinary skill in the art will appreciate that the steps shown and described herein may be performed in other than the recited order and that one or more steps illustrated may be optional. Apparatus and methods may involve the use of any suitable combination of elements, components, method steps, computer-executable instructions, or computer-readable data structures disclosed herein.

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Illustrative embodiments of apparatus and methods in accordance with the principles of the invention will now be described with reference to the accompanying drawings, which form a part hereof. It is to be understood that other embodiments may be utilized, and that structural, functional, and procedural modifications may be made without departing from the scope and spirit of the present invention.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

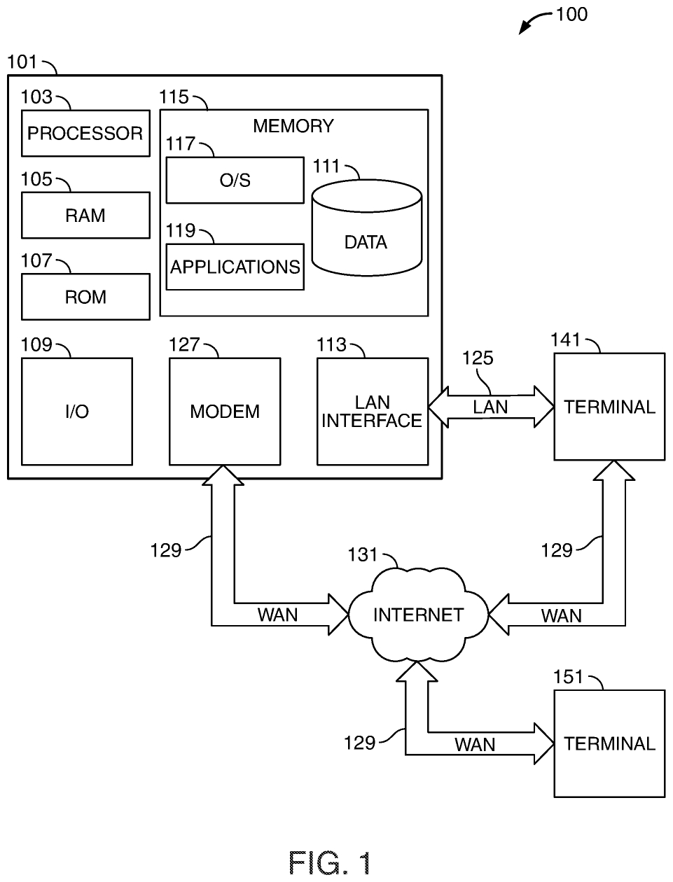

In accordance with principles of the disclosure, FIG. 1 shows an illustrative block diagram of apparatus 100 that includes a computer 101. Computer 101 may alternatively be referred to herein as a “computer system” or “computing device.” Elements of apparatus 100, including computer 101, may be used to implement various aspects of the systems and methods disclosed herein. A “user” of apparatus 100 or computer 101 may include other computer systems or servers or computing devices, such as the program described herein.

Computer 101 may have one or more processors/microprocessors 103 for controlling the operation of the device and its associated components, and may include RAM 105, ROM 107, input/output module 109, and a memory 115. The microprocessors 103 may also execute all software running on the computer 101, e.g., the operating system 117 and applications 119 such as an automatic data layering program and security protocols. Other components commonly used for computers, such as EEPROM or Flash memory or any other suitable components, may also be part of the computer 101.

The memory 115 may include any suitable permanent storage technology—e.g., a hard drive or other non-transitory memory. The ROM 107 and RAM 105 may be included as all or part of memory 115. The memory 115 may store software including the operating system 117 and application(s) 119 (such as an automatic data layering program and security protocols) along with any other data 111 (e.g., historical data, configuration files) needed for the operation of the apparatus 100. Memory 115 may also store applications and data. Alternatively, some or all of computer executable instructions (alternatively referred to as “code”) may be embodied in hardware or firmware (not shown). The microprocessor 103 may execute the instructions embodied by the software and code to perform various functions.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, Wi-Fi, cellular networks, or other suitable frequencies.

Any memory may include any suitable permanent storage technology—e.g., a hard drive or other non-transitory memory. The memory may store software including an operating system and any application(s) (such as an automatic data layering program and security protocols) along with any data needed for the operation of the apparatus and to allow bot monitoring and IoT device notification. The data may also be stored in cache memory, or any other suitable memory.

An input/output (“I/O”) module 109 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 101, the microprocessor 103 may execute the instructions in all or some of the operating system 117, any applications 119 in the memory 115, any other code necessary to perform the functions in this disclosure, and any other code embodied in hardware or firmware (not shown).

In an embodiment, apparatus 100 may consist of multiple computers 101, along with other devices. A computer 101 may be a mobile computing device such as a smartphone or tablet.

Apparatus 100 may be connected to other systems, computers, servers, devices, and/or the Internet 131 via a local area network (LAN) interface 113.

Apparatus 100 may operate in a networked environment supporting connections to one or more remote computers and servers, such as terminals 141 and 151, including, in general, the Internet and “cloud”. References to the “cloud” in this disclosure generally refer to the Internet, which is a worldwide network. “Cloud-based applications” generally refers to applications located on a server remote from a user, wherein some or all the application data, logic, and instructions are located on the internet and are not located on a user's local device. Cloud-based applications may be accessed via any type of internet connection (e.g., cellular or Wi-Fi).

Terminals 141 and 151 may be personal computers, smart mobile devices, smartphones, IoT devices, or servers that include many or all the elements described above relative to apparatus 100. The network connections depicted in FIG. 1 include a local area network (LAN) 125 and a wide area network (WAN) 129 but may also include other networks. Computer 101 may include a network interface controller (not shown), which may include a modem 127 and LAN interface or adapter 113, as well as other components and adapters (not shown). When used in a LAN networking environment, computer 101 is connected to LAN 125 through a LAN interface or adapter 113. When used in a WAN networking environment, computer 101 may include a modem 127 or other means for establishing communications over WAN 129, such as Internet 131. The modem 127 and/or LAN interface 113 may connect to a network via an antenna (not shown). The antenna may be configured to operate over Bluetooth, Wi-Fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 119 (which may be alternatively referred to herein as “plugins,” “applications,” or “apps”) may include computer-executable instructions for an automatic data layering program and security protocols, as well as other programs. In an embodiment, one or more programs, or aspects of a program, may use one or more AI/ML algorithm(s). The various tasks may be related to analyzing and categorizing various data to layer the data according to levels of access.

Computer 101 may also include various other components, such as a battery (not shown), speaker (not shown), a network interface controller (not shown), and/or antennas (not shown).

Terminal 151 and/or terminal 141 may be portable devices such as a laptop, cell phone, tablet, smartphone, server, or any other suitable device for receiving, storing, transmitting and/or displaying relevant information. Terminal 151 and/or terminal 141 may be other devices such as remote computers or servers. The terminals 151 and/or 141 may be computers where a user is interacting with an application.

Any information described above in connection with data 111, and any other suitable information, may be stored in memory 115. One or more of applications 119 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, hand-held or laptop devices, tablets, mobile phones, smartphones, other Computers, and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, IoT devices, and the like.

Aspects of the invention may be described in the general context of computer-executable instructions, such as program modules, executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network, e.g., cloud-based applications. In a distributed computing environment, program modules may be located in both local and remote computer storage media including memory storage devices.

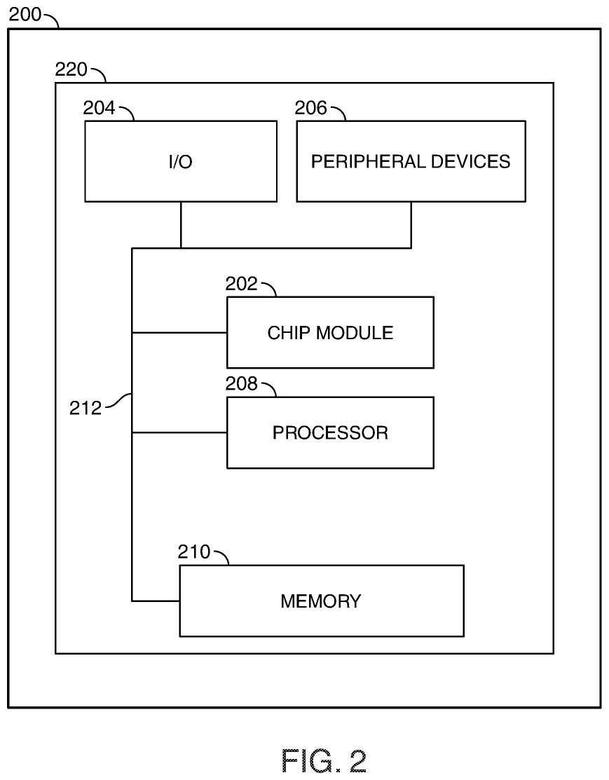

FIG. 2 shows illustrative apparatus 200 that may be configured in accordance with the principles of the disclosure. Apparatus 200 may be a server or computer with various peripheral devices 206. Apparatus 200 may include one or more features of the apparatus shown in FIGS. 1-6. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device, an display (LCD, LED, OLED, etc.), a touchscreen or any other suitable media or devices; peripheral devices 206, which may include other computers; logical processing device 208, which may compute data information and structural parameters of various applications; and machine-readable memory 210.

Machine-readable memory 210 may be configured to store in machine-readable data structures: machine-executable instructions (which may be alternatively referred to herein as “computer instructions” or “computer code”), applications, signals, recorded data, and/or any other suitable information or data structures. The instructions and data may be encrypted.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

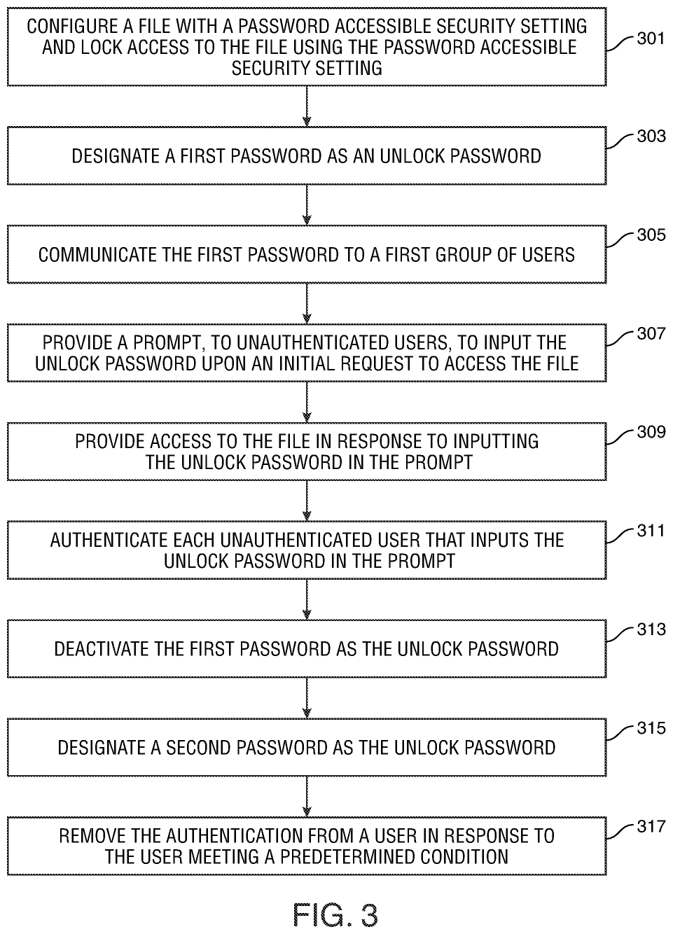

FIG. 3 shows an illustrative flowchart in accordance with principles of the disclosure. At step 301, methods may include configuring a file with a password-accessible security setting and locking access to the file using the password-accessible security setting. At step 303, methods may include designating a first password as an unlock password. At step 305, methods may include communicating the first password to a first group of users.

At step 307, methods may include providing a prompt, to unauthenticated users, to input the unlock password upon an initial request to access the file. At step 309, methods may include providing access to the file in response to inputting the unlock password in the prompt. At step 311, methods may include authenticating each unauthenticated user that inputs the unlock password in the prompt.

At step 313, methods may include deactivating the first password as the unlock password. At step 315, methods may include designating a second password as the unlock password. At step 317, methods may include removing the authentication from a user in response to the user meeting a predetermined condition.

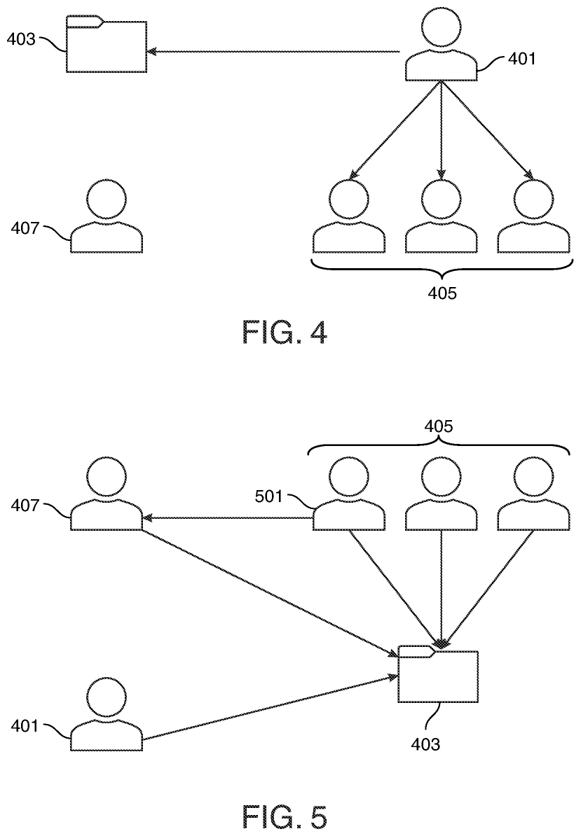

FIG. 4 shows an illustrative diagram in accordance with principles of the disclosure. File owner 401 may create file 403. File owner 401 may have access to file 403. File owner 401 may setup an unlock password for file 403. File owner 401 may share the unlock password with group 405. File owner 401 may decide not to share the unlock password with unintended user 407.

FIG. 5 shows an illustrative diagram in accordance with principles of the disclosure. File owner 401 may be authenticated. File owner 401 may have access to file 403. Group 405 may input the unlock password. Group 405 may be authenticated. Group 405 may have access to file 403.

Member 501 of group 405 may share the unlock password with unintended user 407. Unintended user 407 may input the unlock password. Unintended user 407 may be authenticated. Unintended user 407 may have access to file 403.

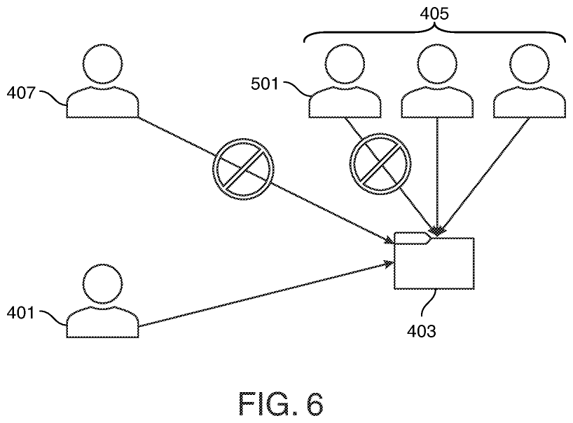

FIG. 6 shows an illustrative diagram in accordance with principles of the disclosure. File owner 401 may remove authentication from unintended user 407. File owner 401 may remove authentication from member 501. File owner 401 may change the unlock password. Unintended user 407 and member 501 may not have the new unlock password. Unintended user 407 and member 501 may no longer be authenticated. Unintended user 407 and member 501 may no longer have access to file 403. The other members of group 405 may be authenticated. The other members of group 405 may have access to file 403 without requiring the other members of group 405 to input the new unlock password.

Thus, systems and methods for OWNER-MANAGED PASSWORD BASED FILE ACCESS have been provided. Persons skilled in the art will appreciate that the present invention can be practiced by other than the described embodiments, which are presented for purposes of illustration rather than of limitation, and that the present invention is limited only by the claims that follow.

What is claimed is:

1. A method for managing access to a file, the method comprising:
configuring the file with a password accessible security setting;
locking access to the file using the password accessible security setting;
designating a first password as one of a plurality of unlock passwords;
communicating the first password to a first group of users;
providing a prompt, to unauthenticated users, to input one of the unlock passwords upon an initial request to access the file;
providing access to the file in response to inputting one of the unlock passwords in the prompt;
authenticating each unauthenticated user that inputs one of the unlock passwords in the prompt;
deactivating the first password as one of the unlock passwords in response to the authentication of every user in the first group of users;
designating a second password as one of the unlock passwords in response to the deactivation of the first password; and
removing the authentication from a user in response to the user meeting a predetermined condition;
wherein:
authenticated users are provided access to the file upon a subsequent request to access the file, without providing the prompt to the authenticated user; and
each user that meets the predetermined condition is prompted to input one of the unlock passwords that corresponds to the second password upon a subsequent request to access the file.

2. The method of claim 1 wherein the prompt further includes a first prompt to input one of the unlock passwords and a second prompt to input a unique identifier, the unique identifier is an email identity, a phone number identity, an enterprise network identity, a biometric identifier or personal identifiable information.

3. The method of claim 2 wherein the authenticating further comprises:
recording the unique identifier input in the second prompt by each unauthenticated user attempting to access the file; and
placing the unique identifier, in response to the user associated with the unique identifier inputting the unlock password in the first prompt, in a list of authenticated users stored with the file.

4. The method of claim 1 wherein the predetermined condition includes at least one of the following:
an elapse of a first predetermined time period from the deactivation of the first password;
a change in a clearance level of the user; and
an elapse of a second predetermined time period from the authentication of the user, wherein the user is not a member of the first group of users.

5. The method of claim 1 further comprising:
generating an alert in response to the authentication of each unauthenticated user.

6. The method of claim 1 wherein the file can be accessed through the cloud, a local network or a local hard drive.

7. The method of claim 2 wherein the designating the first password further comprises:
designating a third password as one of the unlock passwords;
designating a fourth password as one of the unlock passwords;
designating a fifth password as one of the unlock passwords; and
designating a sixth password as one of the unlock passwords.

8. The method of claim 7 wherein the communicating the first password comprises:
communicating the third password to a second group of users;
communicating the fourth password to a third group of users;
communicating the fifth password to a fourth group of users; and
communicating the sixth password to a fifth group of users.

9. The method of claim 8 wherein the authenticating further comprises:
associating the unique identifier of each user which input the third password with a first status;
associating the unique identifier of each user which input the fourth password with a second status;
associating the unique identifier of each user which input the fifth password with a third status;
associating the unique identifier of each user which input the sixth password with a fourth status; and
storing all the associations in a list of authenticated users;
wherein:
each user with the first status is granted read-only access to the file;
each user with the second status is granted reading and commenting access to the file;
each user with the third status is granted reading, commenting and editing access to the file;
each user with the fourth status is granted reading, commenting and editing access to the file, viewing and editing access to the list of authenticated users and access to view details about each user that accessed the file;
the details are stored with the file; and
the details include a length of time each user accessed the file, the number of times each user accessed the file, comments each user made on the file and edits each user made to the file.

10. The method of claim 9 wherein each user with the fourth status is further granted access to view and edit the first group of users and the predetermined conditions.

11. One or more non-transitory computer-readable media storing computer-executable instructions, which when executed by a processor on a computer system, perform a method of managing access to a file, the method comprising:
configuring the file with a password accessible security setting;
locking access to the file using the password accessible security setting;
designating a first password as one of a plurality of unlock passwords;
communicating the first password to a first group of users;
providing a prompt, to unauthenticated users, to input one of the unlock passwords upon an initial request to access the file;
providing access to the file in response to inputting one of the unlock passwords in the prompt;
authenticating each unauthenticated user that inputs one of the unlock passwords in the prompt;
deactivating the first password as one of the unlock passwords in response to the authentication of every user in the first group of users;
designating a second password as one of the unlock passwords in response to the deactivation of the first password; and
removing the authentication from a user in response to the user meeting a predetermined condition;
wherein:
authenticated users are provided access to the file upon a subsequent request to access the file, without providing the prompt to the authenticated user; and
each user that meets the predetermined condition is prompted to input one of the unlock passwords that corresponds to the second password upon a subsequent request to access the file.

12. The non-transitory computer-readable media of claim 11 wherein the prompt further includes a first prompt to input one of the unlock passwords and a second prompt to input a unique identifier, the unique identifier is an email identity, a phone number identity, an enterprise network identity, a biometric identifier or personal identifiable information.

13. The non-transitory computer-readable media of claim 12 wherein the authenticating further comprises:
recording the unique identifier input in the second prompt by each unauthenticated user attempting to access the file; and
placing the unique identifier, in response to the user associated with the unique identifier inputting the unlock password in the first prompt, in a list of authenticated users stored with the file.

14. The non-transitory computer-readable media of claim 11 wherein the predetermined condition includes at least one of the following:
an elapse of a first predetermined time period from the deactivation of the first password;
a change in a clearance level of the user; and
an elapse of a second predetermined time period from the authentication of the user, wherein the user is not a member of the first group of users.

15. The non-transitory computer-readable media of claim 11, the method further comprising:
generating an alert in response to the authentication of each unauthenticated user.

16. The non-transitory computer-readable media of claim 11 wherein the file can be accessed through the cloud, a local network or a local hard drive.

17. The non-transitory computer-readable media of claim 12 wherein the designating the first password further comprises:
designating a third password as one of the unlock passwords;
designating a fourth password as one of the unlock passwords;
designating a fifth password as one of the unlock passwords; and
designating a sixth password as one of the unlock passwords.

18. The non-transitory computer-readable media of claim 17 wherein the communicating the first password comprises:
communicating the third password to a second group of users;
communicating the fourth password to a third group of users;
communicating the fifth password to a fourth group of users; and
communicating the sixth password to a fifth group of users.

19. The non-transitory computer-readable media of claim 18 wherein the authenticating further comprises:
associating the unique identifier of each user which input the third password with a first status;
associating the unique identifier of each user which input the fourth password with a second status;
associating the unique identifier of each user which input the fifth password with a third status;
associating the unique identifier of each user which input the sixth password with a fourth status; and
storing all the associations in a list of authenticated users;
wherein:
each user with the first status is granted read-only access to the file;
each user with the second status is granted reading and commenting access to the file;
each user with the third status is granted reading, commenting and editing access to the file;
each user with the fourth status is granted reading, commenting and editing access to the file, viewing and editing access to the list of authenticated users and access to view details about each user that accessed the file;
the details are stored with the file; and
the details include a length of time each user accessed the file, the number of times each user accessed the file, comments each user made on the file and edits each user made to the file.

20. The non-transitory computer-readable media of claim 19 wherein each user with the fourth status is further granted access to view and edit the first group of users and the predetermined conditions.
